(19) United States
(12) Patent Application Publication
(10) Pub. No.: US 2021/0097459 A1
(43) Pub. Date: Apr. 1, 2021

(54) WORKER ASSIGNMENT SYSTEM AND WORKER ASSIGNMENT DEVICE

(71) Applicant: Hitachi, Ltd., Tokyo (JP)

(72) Inventors: Masayoshi ISHIBASHI, Tokyo (JP); Hideyuki MAKI, Tokyo (JP); Toshiyuki NAKAMURA, Tokyo (JP)

(21) Appl. No.: 16/812,407

(22) Filed: Mar. 9, 2020

(30) Foreign Application Priority Data
Sep. 26, 2019 (JP) 2019-175262

(51) Int. Cl. G06Q 10/06; G06F 16/28

(52) U.S. Cl. CPC G06Q 10/06311; G06F 16/285

(57) ABSTRACT

A worker assignment system reflects the development of the assignment of workers and has a calculation unit which calculates a deficient capability number, which is a number of capabilities lacking in the organization at a given time in the future, from first data including information indicating a number of capabilities required for tasks previously performed by the organization and a number of capabilities of workers of the organization. An identification unit identifies a task and a worker suitable for acquiring capabilities of a maximum deficient capability number calculated by the calculation unit based on second data including information indicating a relationship between the capabilities required for the task to be performed by the organization and the capabilities of the workers of the organization. An assignment unit assigns remaining workers of the organization to remaining tasks to be performed and a result of the assignment is output.

### CROSS-REFERENCE TO RELATED APPLICATION

The present application claims priority from Japanese application JP2019-175262, filed on Sep. 26, 2019, the contents of which is hereby incorporated by reference into this application.

### TECHNICAL FIELD

The present invention relates to a worker assignment system and a worker assignment device and, for example, can be suitably applied to a worker assignment system and a worker assignment device which assign a worker of a predetermined organization to a task to be performed by the organization.

### BACKGROUND ART

Under circumstances where the shortage of labor in the manufacturing industry, retail industry and service industry is becoming a serious social issue, the assignment (matching) of workers based on the optimal matching of capabilities required for performing certain tasks and the capability retained by workers is extremely important. Nevertheless, because the work description of the tasks to be performed by the company and the capabilities of regular employees change constantly, it is not easy to perform such optimal matching at such point in time.

With respect to this point, disclosed is a system for extracting required workers without requiring man-hours for updating the training results of workers and the experience of workers, and assigning the most suitable worker based on conditions such as the work shift of workers and the occurrence of problems in past tasks (refer to PTL 1).

### CITATION LIST

### Patent Literature

[PTL 1] Japanese Unexamined Patent Application Publication No. 2014-191377

### SUMMARY OF THE INVENTION

### Problems to be Solved by the Invention

Nevertheless, in order to continuously maintain an organization, such as a company, for a long period, in addition to assigning the most suitable worker that the organization currently has to the task that needs to be performed now, it is also necessary to develop workers so they can handle the tasks that are expected to be required in the future. With the technology described in PTL 1, while it is possible to assign the most suitable worker that the organization currently has, PTL 1 does not give any consideration to the development of workers for the tasks that are expected to be required in the future.

The present invention was devised in view of the foregoing points, and an object of this invention is to propose a worker assignment system and a worker assignment device which reflect the development of workers in the assignment of workers.

### Means to Solve the Problems

In order to achieve the foregoing object, the present invention provides a worker assignment system which assigns a worker of a predetermined organization to a task to be performed by the organization, comprising: a calculation unit which calculates a deficient capability number, which is a number of capabilities lacking in the organization at a given time in a future, from first data including information indicating a number of capabilities required for tasks previously performed by the organization and a number of capabilities of workers of the organization; an identification unit which identifies a task and a worker suitable for acquiring capabilities of a maximum deficient capability number calculated by the calculation unit based on second data including information indicating a relationship between the capabilities required for the task to be performed by the organization and the capabilities of the workers of the organization; an assignment unit which, after assigning the worker identified by the identification unit to the task identified by the identification unit, assigns remaining workers of the organization to remaining tasks to be performed by the organization; and an output unit which outputs a result of the assignment by the assignment unit.

According to the foregoing configuration, because it is possible to assign, after assigning a worker, who is to acquire a certain capability, to a task which will enable such worker to acquire such capability required by the organization, the remaining workers to the remaining tasks, for example, it is possible to develop workers required by the organization in the future.

### Advantageous Effects of the Invention

According to the present invention, it is possible to reflect the development of workers in the assignment of workers.

### BRIEF DESCRIPTION OF DRAWINGS

FIG. 1 is a diagram showing an example of the configuration of the worker assignment system according to the first embodiment.

FIG. 2 is a diagram showing an example of the data structure of the work description database according to the first embodiment.

FIG. 3 is a diagram showing an example of the data structure of the worker capability database according to the first embodiment.

FIG. 4 is a diagram showing an example of the data structure of the matching condition database according to the first embodiment.

FIG. 5 is a diagram showing an example of the data structure of the work history database according to the first embodiment.

FIG. 6 is a diagram showing an example of the data structure of the capability development method database according to the first embodiment.

FIG. 7 is a diagram showing an example of the work task schedule table according to the first embodiment.

FIG. 8 is a diagram showing an example of the flowchart of the data processing according to the first embodiment.

FIG. 9 is a diagram showing an example of the flowchart of the data processing according to the first embodiment.

### DESCRIPTION OF EMBODIMENTS

An embodiment of the present invention is now explained in detail with reference to the appended drawings. This embodiment relates to a technology of assigning workers (human resources) to tasks in various types of industries. In this embodiment, upon developing workers, the capability expected to become most required in the future is identified based on the work history, the task and worker most suitable for acquiring the identified capability are identified, and, after the identified worker is assigned to the identified task, other tasks and other workers are assigned to achieve total optimization. According to this embodiment, it is possible to assign workers in a manner in which workers to become necessary in the future can be developed while suppressing the influence on the ongoing work. This is now explained in detail.

### (1) First Embodiment

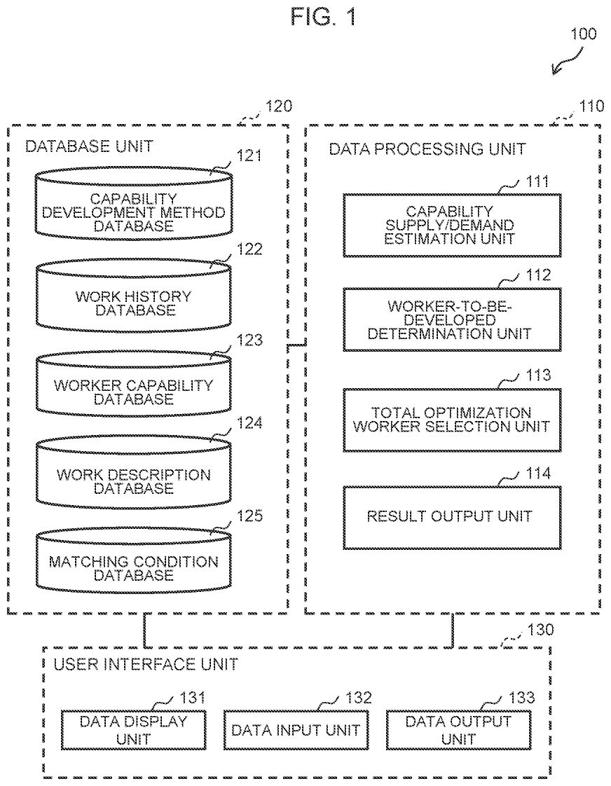

In FIG. 1, reference numeral 100 shows a worker assignment system as a whole according to the first embodiment.

FIG. 1 is a diagram showing an example of the configuration of the worker assignment system 100. The worker assignment system 100 is, for example, a system which creates a worker selection plan indicating the assignment of workers of an organization to the tasks to be performed by that organization, which is also a worker selection plan which gives consideration to the development of workers.

More specifically, the worker assignment system 100 is configured by including a data processing unit 110, a database unit 120, and a user interface unit 130. The data processing unit 110 is communicably connected to the database unit 120 and the user interface unit 130. The data processing unit 110 and the database unit 120 and the user interface unit 130 may be connected via a network, or connected without going through a network.

The data processing unit 110, the database unit 120 and the user interface unit 130 are respectively, for example, a computer such as a laptop computer or a server device, and are configured by including a CPU (Central Processing Unit), a RAM (Random Access Memory), a ROM (Read Only Memory), a HDD (Hard Disk Drive), a communication device (all not shown), and the like. Note that the computer may also comprise, in addition to the foregoing hardware configuration, an input device such as a mouse, keyboard, and microphone, and an output device such as a display, and speaker.

The functions of the computer (capability supply/demand estimation unit 111, worker-to-be-developed determination unit 112, total optimization worker selection unit 113, result output unit 114, data display unit 131, data input unit 132, data output unit 133, etc.) may be realized, for example, by the CPU reading the programs stored in the ROM into the RAM and executing such programs (software), or with hardware such as a dedicated circuit, or based on a combination of software and hardware. Moreover, a part of the functions of the computer may be realized by another computer that is communicable with that computer.

Note that the worker assignment system 100 is not limited to the foregoing mode and, for example, the data processing unit 110 and the database unit 120 may be the server device, and the user interface unit 130 may be the client device.

The data processing unit 110 comprises a capability supply/demand estimation unit 111, a worker-to-be-developed determination unit 112, a total optimization worker selection unit 113, and a result output unit 114.

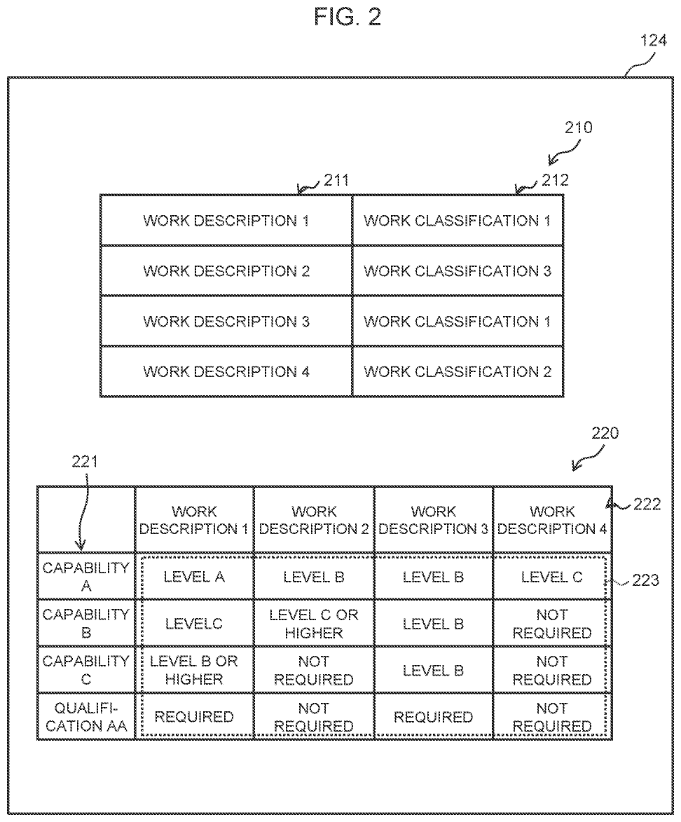

The database unit 120 comprises a capability development method database 121, a work history database 122, a worker capability database 123, a work description database 124, and a matching condition database 125. Note that the respective databases (DB) will be explained later with reference to FIG. 2 to FIG. 6.

The capability supply/demand estimation unit 111, for example, estimates the capabilities required in the future by using the transition of the number of capabilities (capability number) of workers that were required for the tasks stored in the work history database 122, and the transition of the capability number of workers retained by the organization. The worker-to-be-developed determination unit 112, for example, determines the worker to acquire the capabilities required in the future, which were estimated by the capability supply/demand estimation unit 111, by using the information of capabilities retained by the worker stored in the worker capability database 123. The total optimization worker selection unit 113, for example, selects the worker for the task (work task schedule table 710 described later) to be performed by the organization based on the information stored in the worker capability database 123, the work description database 124, and the matching condition database 125. The result output unit 114, for example, sends the result of the worker selection (for example, worker selection plan) by the total optimization worker selection unit 113 to the user interface unit 130.

The user interface unit 130 comprises a data display unit 131, a data input unit 132, and a data output unit 133.

The data display unit 131 displays the data (for example, worker selection plan) processed by the data processing unit 110, and displays data when a worker selection administrator inputs or corrects data. The data input unit 132 performs processing of inputting data into the worker assignment system 100 from a keyboard or another system. The data output unit 133 performs processing of outputting the data processed by the user interface unit 130 to the database unit 120, a printer not shown, or another computer not shown.

FIG. 2 is a diagram showing an example of the data structure of the work description database 124. The work description database 124 stores, for each description of task of the work (work description), information which prescribes the capabilities required for performing such work description (for example, capabilities of workers). The work description database 124 comprises a work description classification table 210, and a work description capability table 220.

The work description classification table 210 stores information indicating the work classification to which each work description belongs. A work classification is a category in which the work descriptions have been complied for each similar description. More specifically, the work description classification table 210 stores information in which the work description name 211 and the work classification name 212 have been associated. The work description name 211 is identifying information capable of identifying the work description. The work classification name 212 is identifying information capable of identifying the work classification. According to the work description classification table 210, the worker assignment system 100 can identify, for example, the work description belonging to the work classification.

The work description capability table 220 stores information indicating, with regard to all capabilities and qualifications, whether each work description requires such capabilities and qualifications, and a level of the required capabilities. In the following explanation, the capabilities and qualifications may be collectively referred to as “capability/qualification”.

More specifically, the work description capability table 220 stores information in which the capability/qualification name 221, the work description name 222 and the required level 223 have been associated. The capability/qualification name 221 is identifying information capable of identifying the capabilities and qualifications. The work description name 222 is identifying information capable of identifying the work description. The required level 223 is identifying information capable of identifying the level of capabilities required by the worker to perform the work description, or the possession of qualifications required by the worker to perform the work description.

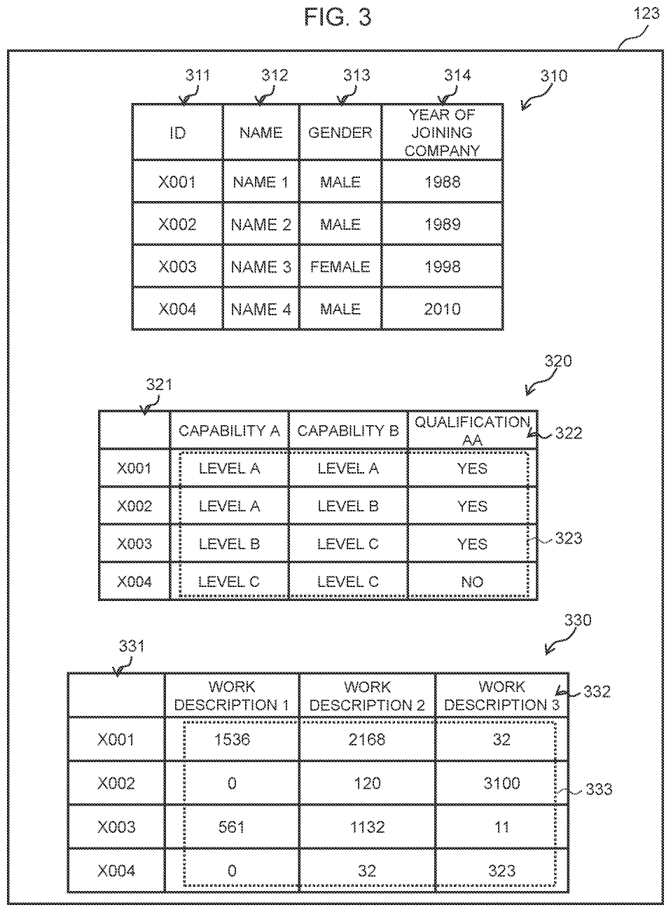

FIG. 3 is a diagram showing an example of the data structure of the worker capability database 123. The worker capability database 123 stores information pertaining to the capabilities retained by the worker. The worker capability database 123 comprises a worker table 310, a worker qualification table 320, and a worker empirical value table 330.

The worker table 310 stores the basic information of the worker. More specifically, the worker table 310 stores information in which the ID 311, the name 312, the gender 313, and the year of joining company 314 are associated. The ID 311 is identifying information capable of identifying the worker. The name 312 is information indicating the name of the worker. The gender 313 is information indicating the gender of the worker. The year of joining company 314 is information indicating the year that the worker joined the organization.

The worker qualification table 320 stores information indicating the capability level and qualifications retained by each worker. More specifically, the worker qualification table 320 stores information in which the ID 321, the capability/qualification 322, and the retention level 323 have been associated. The ID 321 is identifying information capable of identifying the worker. The capability/qualification 322 is identifying information capable of identifying the capabilities and qualifications. The retention level 323 is identifying information capable of identifying the level of capabilities retained by the worker, or the possession of qualifications retained by the worker.

The worker empirical value table 330 stores, as information indicating the worker's experience, information indicating the number of days that the worker was engaged in each work description. More specifically, the worker empirical value table 330 stores information in which the ID 331, the work description name 332, and the number of days of engagement 333 have been associated. The ID 331 is identifying information capable of identifying the worker. The work description name 332 is identifying information capable of identifying the work description. The number of days of engagement 333 is information indicating the number of days that the worker was engaged in that work description.

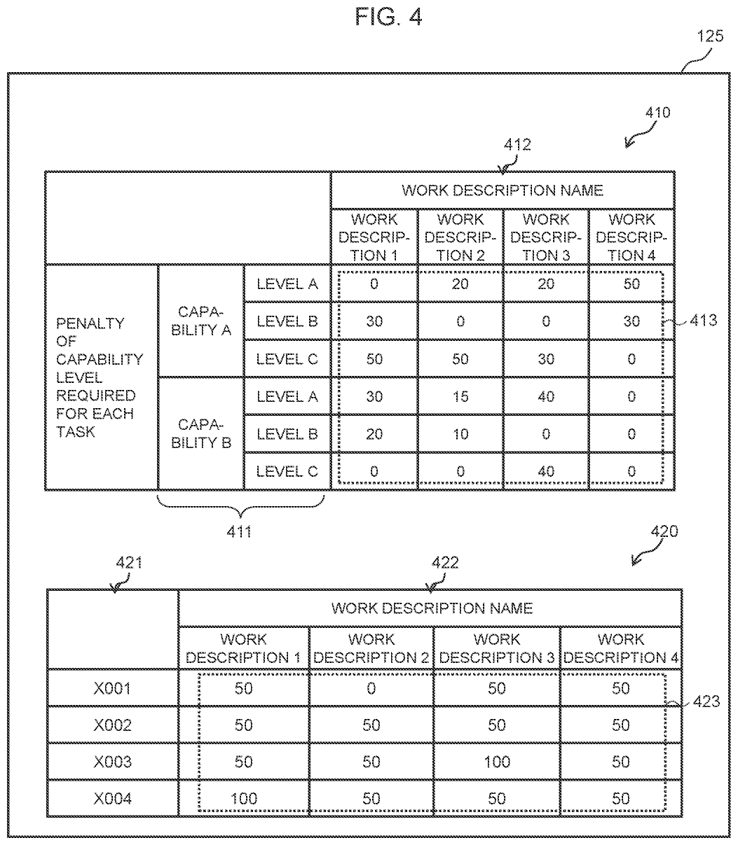

FIG. 4 is a diagram showing an example of the data structure of the matching condition database 125. The matching condition database 125 stores information prescribing the standard upon assigning a task to a worker. The matching condition database 125 comprises a penalty rule table 410, and a prescribed worker table 420.

The penalty rule table 410 stores information indicating the penalty against the level of each capability required for each work description. More specifically, the penalty rule table 410 stores information in which the capability level 411, the work description name 412, and the penalty 413 have been associated. The capability level 411 is identifying information capable of identifying the level of capability. The work description name 412 is identifying information capable of identifying the work description. The penalty 413 is information indicating the deviation (penalty) from the optimal capability level upon performing the work description.

A penalty is normally assigned as a whole number from “0” to “100”. For example, with regard to “capability A” required for “work description 2”, it would be optimal (penalty “0”) to assign a worker having “capability A” of “level B”, and, when a worker having “capability A” of “level A” is assigned, a deviation of “20” (penalty “20”) will arise in comparison to the optimal assignment, and, when a worker having “capability A” of “level C” is assigned, a deviation of “50” (penalty “50”) will arise in comparison to the optimal assignment. In this example, because it would be a loss for the organization in both cases of over performance (“level A”) and under performance (“level C”), the penalty has been set as described above.

The prescribed worker table 420 stores information on preferentially assigning an arbitrary worker to an arbitrary task, or preferably not assigning an arbitrary worker to an arbitrary task. More specifically, the prescribed worker table 420 stores information in which the ID 421, the work description name 422, and the preferential assignment 423 have been associated. The ID 421 is identifying information capable of identifying the worker. The work description name 422 is identifying information capable of identifying the work description. The preferential assignment 423 is information indicating whether to assign a worker to a work description, prohibit the assignment of a worker to a work description, or not setting any condition (information for identifying the preferential assignment of a worker to a task).

In the example of the prescribed worker table 420, when designating an arbitrary worker and assigning such worker to an arbitrary task, “0” is stored in the preferential assignment 423. When prohibiting the assignment of an arbitrary worker to an arbitrary task, “100” is stored in the preferential assignment 423. When no specific condition is to be set, “50” is stored in the preferential assignment 423.

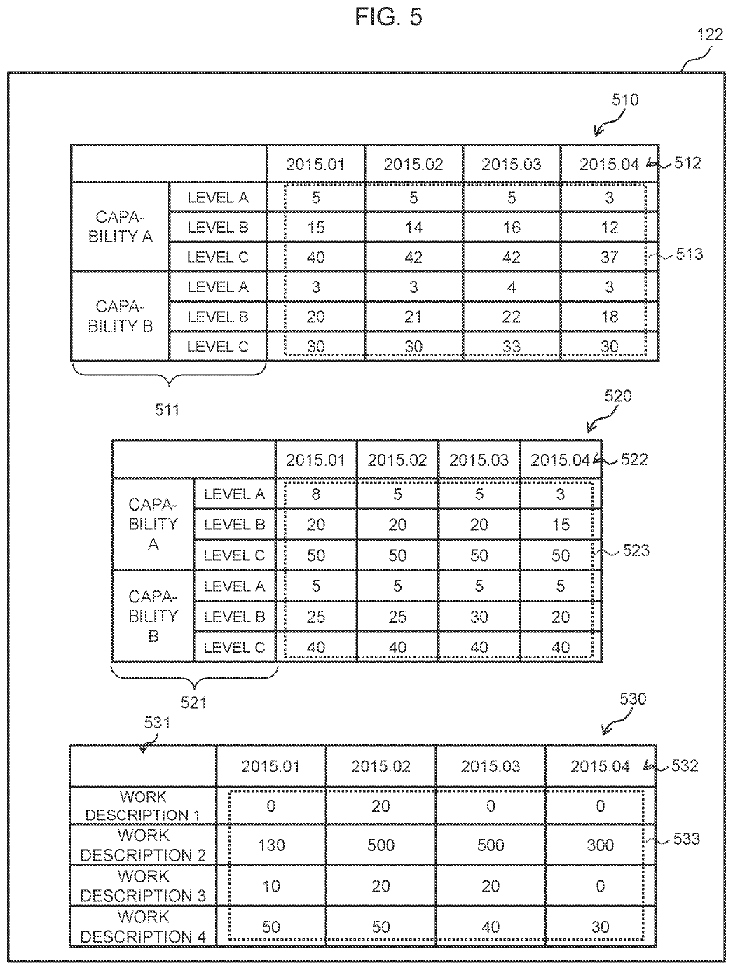

FIG. 5 is a diagram showing an example of the data structure of the work history database 122. The work history database 122 stores information indicating the history of past work; more specifically, information indicating the number of capabilities required in the tasks previously performed by the organization and the number of capabilities of the workers of the organization. The work history database 122 comprises a required capability transition table 510, a retained capability transition table 520, and a penalty management table 530.

The required capability transition table 510 stores, for each date, the total level of each capability required for the tasks previously performed by the organization. Information of the required capability transition table 510 is generated from the work task data of the organization's work. The work task data includes information in which the work description of the tasks constituting the task and the capability level and qualifications required for the work description have been associated.

More specifically, the required capability transition table 510 stores information in which the capability level 511, the date 512, and the total capability number 513 have been associated. The capability level 511 is identifying information capable of identifying the level of capability. The date 512 is information indicating a specified date. The total capability number 513 is information indicating the total number of levels of the capability required for the tasks previously performed by the organization on the specified date.

The retained capability transition table 520 stores, for each data, the total level of each capability previously retained by the workers of the organization. Information of the retained capability transition table 520 is generated based on the worker qualification table 320.

More specifically, the retained capability transition table 520 stores information in which the capability level 521, the date 522, and the total capability number 523 have been associated. The capability level 521 is identifying information capable of identifying the level of capability. The date 522 is information indicating a specified date. The total capability number 523 is information indicating the total number of levels of capability previously retained by the workers of the organization on the specified date.

The penalty management table 530 stores, for each data, the penalty average of each work description upon assigning all workers. More specifically, the penalty management table 530 stores information in which the work description name 531, the date 532, and the penalty average 533 have been associated. The work description name 531 is identifying information capable of identifying the work description. The date 532 is information indicating a specified date. The penalty average 533 is information indicating the penalty average of the work description on the specified date.

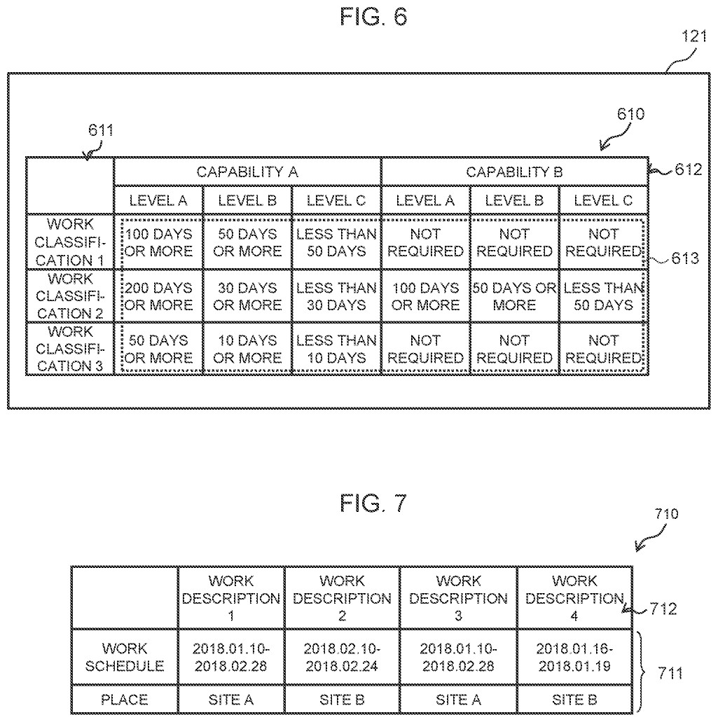

FIG. 6 is a diagram showing an example of the data structure of the capability development method database 121. The capability development method database 121 stores information indicating the conditions for determining whether a worker acquired a certain capability. The capability development method database 121 comprises a capability development method table 610.

The capability development method table 610 stores the number of days (number of reference days) that a worker needs to engage in the work description of the work classification, as a guideline for acquiring a certain capability, for each level of capability. More specifically, the capability development method table 610 stores information in which the work classification name 611, the capability level 612, and the number of reference days 613 have been associated. The work classification name 611 is identifying information capable of identifying the work classification. The capability level 612 is identifying information capable of identifying the level of capability. The number of reference days 613 is information indicating the number of days as the standard for reaching that level of capability.

FIG. 7 is a diagram showing an example of the work task schedule table 710. The work task schedule table 710 stores when and where each work description in a certain type of work is to be performed. The work task schedule table is input, for example, by the worker selection administrator via the data input unit 132.

More specifically, the work task schedule table 710 stores information in which the work plan 711, and the work description name 712 have been associated. The work plan 711 is information including the information of the work schedule and the workplace. The work description name 712 is identifying information capable of identifying the work description.

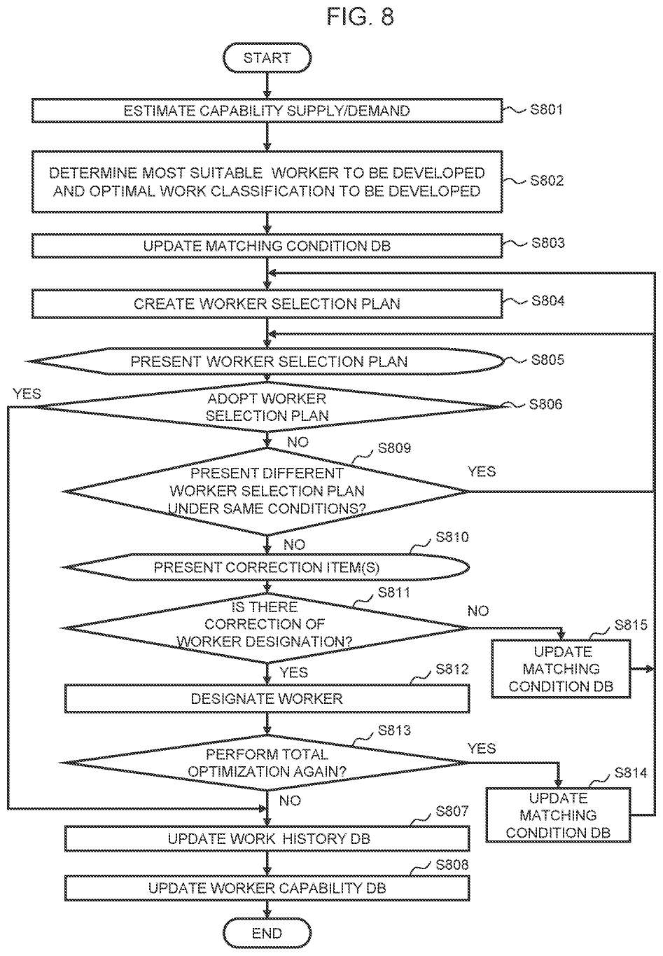

FIG. 8 is a diagram showing an example of the flowchart of the data processing to be executed by the worker assignment system 100.

Foremost, the data processing unit 110 estimates the capability supply/demand (step S801). The data processing unit 110 extrapolates, via time series data analysis, the transition (for example, information of the required capability transition table 510) of each capability number (total number of demand capabilities) of workers previously required for the tasks of the work stored in the work history database 122, and thereby obtains a total number of expected demand capabilities expected to be required by the organization in an arbitrary time in the future (for example, 3 years later). Similarly, the data processing unit 110 extrapolates, via time series data analysis, the transition (for example, information of the retained capability transition table 520) of each capability number (total number of supply capabilities) of workers previously retained by the organization stored in the work history database 122, and thereby obtains a total number of expected supply capabilities expected to be retained by the organization in an arbitrary time in the future (for example, 3 years later).

Subsequently, the data processing unit 110 obtains a total number of expected deficient capabilities by subtracting the total number of expected supply capabilities from the total number of expected demand capabilities for each level of capability, and determines the level of capability (maximum number of deficient capabilities) in which the total number of expected deficient capabilities will become maximum; that is, the level of capability in which the total number of expected supply capabilities will be most deficient relative to the total number of expected demand capabilities.

Note that, as the time series data analysis described above, while classic time series analyzing methods such as an autoregressive moving average model (ARMA model: AutoRegressive Moving Average model) or a general autoregression model (AR model: AutoRegressive model) may be used, methods based on machine learning such as RNN (Recurrent Neural Network) or LSTM (Long Short Term Memory) may also be used.

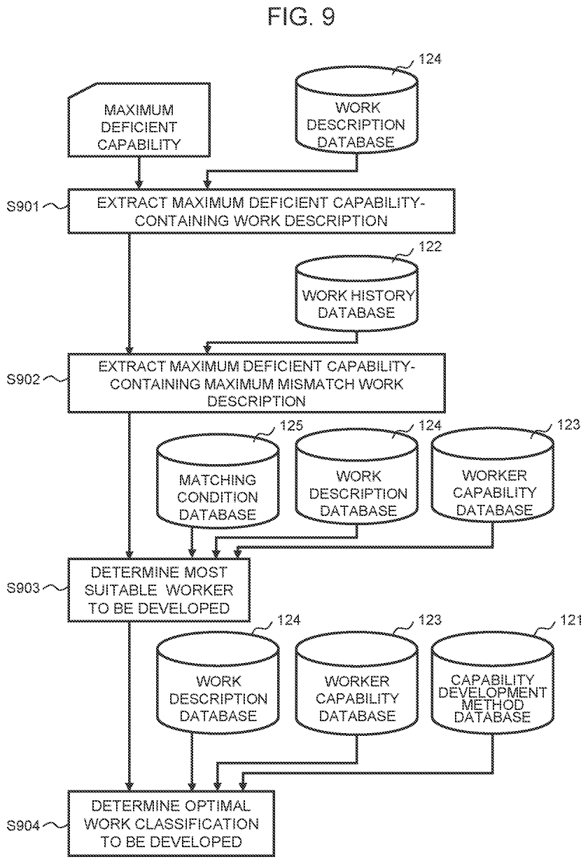

Next, the data processing unit 110 determines the most suitable worker to be developed, which is the worker to acquire the maximum number of deficient capabilities determined in step S801, and the optimal work classification to be developed to be engaged in by such worker for acquiring the maximum number of deficient capabilities (step S802). Details of the foregoing processing will be explained later with reference to FIG. 9.

Next, the data processing unit 110 updates the matching condition database 125 for preferentially assigning the task of the work description of the optimal work classification to be developed to the most suitable worker to be developed determined in step S802 (step S803). For example, when the ID of the most suitable worker to be developed is “X003”, the optimal work classification to be developed is “work classification 1”, and “work classification 1” includes “work description 1” and “work description 3”, the data processing unit 110 assigns “0” in the columns of “work description 1” and “work description 3” of “X003” in the prescribed worker table 420 of the matching condition database 125.

Next, the data processing unit 110 creates one or more assignment plans (worker selection plans) for assigning a worker to the task to be performed by the organization (each task of work included in the work task schedule table 710) (step S804).

In step S804, after assigning the most suitable worker to be developed, the data processing unit 110 assigns the remaining workers to the remaining tasks to be performed by the organization based on mathematical programming so that the total optimization ratio becomes greatest (sum of penalties becomes smallest) by using the work description capability table 220 of the work description database 124, the worker qualification table 320 of the worker capability database 123, and the penalty rule table 410 and the prescribed worker table 420 of the matching condition database 125. Furthermore, the data processing unit 110 creates an arbitrary number of worker selection plans by using a condition of excluding the worker selection plan in which the sum of penalties becomes smallest in addition to the worker selection plan in which the sum of penalties becomes smallest.

Next, the user interface unit 130 presents the details of the worker selection plan in which the total optimization ratio is greatest among the worker selection plans determined in step S804 (step S805).

Next, the user interface unit 130 urges the worker selection administrator to determine whether or not to adopt the worker selection plan presented in step S805 (step S806).

When the worker selection administrator is to adopt the worker selection plan presented in step S805, the data processing unit 110 updates the work history database 122 (step S807). For example, data the processing unit 110 updates the required capability transition table 510 based on the work task data, updates the retained capability transition table 520 by referring to the capability development method database 121 and determining the capability level of the worker based on the worker selection plan adopted in step S806, and updating the penalty management table 530 based on the penalty of each work description of the worker selection plan.

Next, the data processing unit 110 updates the worker capability database 123 (step S808). For example, the data processing unit 110 updates the worker empirical value table 330 based on the worker selection plan adopted in step S806. Moreover, the data processing unit 110 updates the worker qualification table 320 of the worker whose capability level was raised.

When the worker selection administrator determines not to adopt the worker selection plan in S806, the user interface unit 130 urges the worker selection administrator to determine whether to display another worker selection plan of the same matching condition, or change the matching condition (step S809).

When the worker selection administrator selects to display another worker selection plan of the same matching condition in step S806, the user interface unit 130 presents details of the worker selection plan in which the total optimization ratio is the second highest after the previously presented worker selection plan among the worker selection plans determined in step S802 (step S804), advances the processing to step S805, and continues with the processing.

When the worker selection administration selects to create a worker selection plan by changing the matching condition in step S806, the user interface unit 130 presents the correction items of the matching condition (step S810).

Among the correction items of the matching condition presented in step S810, the user interface unit 130 urges the worker selection administrator to determine whether or not to assign a specific worker to a specific task (step S811).

When the worker selection administrator determines to assign a specific worker to a specific task in step S811, the data processing unit 110 determines that a specific worker will be assigned to a specific task (step S812).

The user interface unit 130 urges the worker selection administrator to determine, upon assigning a specific worker to a specific task, whether to newly implement total optimization in relation to another worker selection (step S813).

When the worker selection administrator does not select to newly implement total optimization in step S813, the user interface unit 130 advances the processing to step S807.

When the worker selection administrator selects to newly implement total optimization in step S813, the data processing unit 110 updates the matching condition database 125 (prescribed worker table 420) for the total optimization (step S814), and advances the processing to step S804.

When the worker selection administrator determines not to assign a specific worker to a specific task in step S811, the data processing unit 110 updates the matching condition database 125 (penalty rule table 410) for the total optimization (step S815), and advances the processing to step S804.

FIG. 9 is a diagram showing an example of a flowchart of the data processing for determining the most suitable worker to be developed and the optimal work classification to be developed.

Foremost, the data processing unit 110 extracts the work description (maximum number of deficient capabilities-containing work description) which requires the maximum number of deficient capabilities by using the information of the work description capability table 220 of the work description database 124 (step S901).

Next, the data processing unit 110 extracts the work description (maximum number of deficient capabilities-containing maximum mismatch work description) in which the penalty average in an arbitrary period (for example, 6 months) is highest among the maximum number of deficient capabilities-containing work descriptions extracted in step S901 by using the information of the penalty management table 530 of the work history database 122 (step S902).

Next, the data processing unit 110 determines, as the most suitable worker to be developed, a worker with the smallest penalty regarding the level of capability other than the maximum number of deficient capabilities (worker with the most capabilities other than the maximum number of deficient capabilities) among the workers with no level of capability required for the extracted maximum number of deficient capabilities-containing maximum mismatch work description by using the work description capability table 220 of the work description database 124, the worker qualification table 320 of the worker capability database 123, and the penalty rule table 410 of the matching condition database 125 (step S903).

Next, the data processing unit 110 determines, as the optimal work classification to be developed, the work classification to which the maximum number of deficient capabilities-containing maximum mismatch work description belongs (work classification in which the most suitable worker to be developed lacks the most experience for acquiring the maximum number of deficient capabilities) by using the capability development method database 121, the worker empirical value table 330 of the worker capability database 123, and the work description classification table 210 of the work description database 124 (step S904).

According to this embodiment, it is possible to reflect the development of workers in the assignment of workers.

### (2) Other Embodiments

Note that while the foregoing embodiment explained a case of applying the present invention to a worker assignment system, the present invention is not limited thereto, and may be broadly applied to various other types of systems, devices, methods, and programs.

Moreover, while the foregoing embodiment explained a case of setting a capability level, the present invention is not limited thereto, and a capability level may be omitted (to put it differently, there may be only one capability level).

Moreover, while the foregoing embodiment explained various types of data using expressions such as “XX table” as a matter of convenience of explanation, there is no limitation in the data structure and, for example, expressions such as “XX information” may also be used.

Moreover, in the foregoing explanation, information such as programs, tables and files that realize the respective function may be stored in a memory, a storage device such as a hard disk or SSD (Solid State Drive), or a storage medium such as an IC card, SD card, or DVD.

The foregoing embodiment, for example, has the following characteristic configuration.

A worker assignment system (for example, worker assignment system 100) or a worker assignment device (for example, data processing unit 110) which assigns a worker (regular employee, contract employee, member or the like, and this may or may not include a dispatched employee) of a predetermined organization (company, corporation, institution, group, etc.) to a task (for example, work description of such task) to be performed by the organization, comprising: a calculation unit (for example, data processing unit 110, capability supply/demand estimation unit 111) which calculates a deficient capability number (for example, total number of expected deficient capabilities), which is a number of capabilities lacking in the organization at a given time in a future (for example, 3 years later), from first data (for example, work history database 122) including information indicating a number of capabilities required for tasks previously performed by the organization and a number of capabilities of workers of the organization; an identification unit (for example, data processing unit 110, worker-to-be-developed determination unit 112) which identifies a task and a worker suitable for acquiring capabilities (for example, maximum number of deficient capabilities) of a maximum deficient capability number calculated by the calculation unit based on second data (for example, work description capability table 220 and worker qualification table 320) including information indicating a relationship between the capabilities required for the task to be performed by the organization and the capabilities of the workers of the organization; an assignment unit (for example, data processing unit 110, total optimization worker selection unit 113) which, after assigning the worker identified by the identification unit to the task identified by the identification unit, assigns remaining workers of the organization to remaining tasks to be performed by the organization; and an output unit (for example, data processing unit 110, result output unit 114) which outputs (for example, sends to the user interface unit 130, displays on a screen, outputs from a printer, sends to another computer, etc.) a result of the assignment (for example, information in which the worker selection plan, work description, and worker to perform the task of such work description are associated) by the assignment unit.

With the foregoing configuration, because it is possible to assign, after assigning a worker, who is to acquire a certain capability, to a task which will enable such worker to acquire such capability required by the organization, the remaining workers to the remaining tasks, for example, it is possible to develop workers required by the organization in the future.

When there are a plurality of tasks suitable for acquiring capabilities of the maximum deficient capability number, the identification unit identifies a task with a highest penalty among the plurality of tasks based on third data (for example, penalty management table 530) including information indicating a penalty, which is a level that the task and the worker assigned by the assignment unit are not suitable (for example, refer to step S902).

With the foregoing configuration, because it is possible to identify a task in which the assignment of a worker is a mismatch, the worker required by the organization can be more appropriately developed while resolving the mismatch of the assignment of a worker.

When there are a plurality of workers suitable for acquiring capabilities of the maximum deficient capability number, the identification unit identifies a worker with a lowest penalty of capabilities other than the capabilities of the maximum deficient capability number among the plurality of workers based on fourth data (for example, penalty rule table 410) including information indicating a penalty, which is a level that the task and the capability are not suitable (for example, refer to step S903).

With the foregoing configuration, because it is possible to reduce the mismatch in the remaining tasks by identifying the worker with the lowest penalty of capabilities other than the capabilities of the maximum deficient capability number, for example, it is possible to more appropriately develop the worker required by the organization while reducing the losses suffered by the organization.

The first data includes fifth data (for example, required capability transition table 510) indicating a number of capabilities for each hour required in the task to be performed by the organization, and sixth data (for example, retained capability transition table 520) indicating a number of capabilities for each hour retained by the worker of the organization, and the calculation unit calculates a required capability number (for example, total number of expected demand capabilities) which indicates a number of capabilities required by the organization and a retained capability number (for example, total number of expected supply capabilities) which indicates a number of capabilities retained by the worker of the organization at the given time from the fifth data and the sixth data, and calculates the deficient capability number from the calculated required capability number and retained capability number (for example, refer to step S801).

A level is set to capabilities of workers of the organization, the second data includes information indicating a relationship of a level of capabilities required for the task to be performed by the organization and a level of capabilities of the worker of the organization, the worker assignment system further comprises a determination unit (for example, data processing unit 110) which determines a level of capabilities of the worker of the organization based on seventh data (for example, capability development method table 610) which prescribes, for each classification of work, conditions for determining that the level has reached a predetermined capability level, and the identification unit identifies a task and a worker suitable for acquiring the level of capabilities of the maximum deficient capability number based on the second data.

With the foregoing configuration, data of the granularity of tasks is used upon assigning a worker to a task, and data of the granularity of the classification of work is used upon determining the capability level. For example, when similar type of tasks have been performed, it will be possible to deem that the worker gained experience in the classification of the same type of task, and the worker can be assigned more in line with actual practice.

The identification unit identifies a classification of work to which belongs the task suitable for acquiring the level of capabilities of the maximum deficient capability number (for example, refer to step S904) and identifies the task belonging to the identified classification of work based on the second data (for example, refer to step S803).

With the foregoing configuration, because it is possible to identify the classification of work to which belongs the task suitable for acquiring the level of capabilities of the maximum deficient capability number and identify the task belonging to the identified classification of work, for example, the worker can be developed more efficiently by assigning the identified task to the worker to be developed to the extent possible.

Moreover, the foregoing configuration may be suitably changed, rearranged, combined or omitted to the extent that it does not deviate from the subject matter of the present invention.

### REFERENCE SIGNS LIST

100 . . . worker assignment system, 110 . . . data processing unit, 111 . . . capability supply/demand estimation unit, 112 . . . worker-to-be-developed determination unit, 113 . . . total optimization worker selection unit, 114 . . . result output unit.

1. A worker assignment system which assigns a worker of a predetermined organization to a task to be performed by the organization, comprising:
a calculation unit which calculates a deficient capability number, which is a number of capabilities lacking in the organization at a given time in a future, from first data including information indicating a number of capabilities required for tasks previously performed by the organization and a number of capabilities of workers of the organization;
an identification unit which identifies a task and a worker suitable for acquiring capabilities of a maximum deficient capability number calculated by the calculation unit based on second data including information indicating a relationship between the capabilities required for the task to be performed by the organization and the capabilities of the workers of the organization;
an assignment unit which, after assigning the worker identified by the identification unit to the task identified by the identification unit, assigns remaining workers of the organization to remaining tasks to be performed by the organization; and
an output unit which outputs a result of the assignment by the assignment unit.

2. The worker assignment system according to claim 1,
wherein, when there are a plurality of tasks suitable for acquiring capabilities of the maximum deficient capability number, the identification unit identifies a task with a highest penalty among the plurality of tasks based on third data including information indicating a penalty, which is a level that the task and the worker assigned by the assignment unit are not suitable.

3. The worker assignment system according to claim 1,
wherein, when there are a plurality of workers suitable for acquiring capabilities of the maximum deficient capability number, the identification unit identifies a worker with a lowest penalty of capabilities other than the capabilities of the maximum deficient capability number among the plurality of workers based on fourth data including information indicating a penalty, which is a level that the task and the capability are not suitable.

4. The worker assignment system according to claim 1,
wherein the first data includes fifth data indicating a number of capabilities for each hour required in the task to be performed by the organization, and sixth data indicating a number of capabilities for each hour retained by the worker of the organization, and
wherein the calculation unit calculates a required capability number which indicates a number of capabilities required by the organization and a retained capability number which indicates a number of capabilities retained by the worker of the organization at the given time from the fifth data and the sixth data, and calculates the deficient capability number from the calculated required capability number and retained capability number.

5. The worker assignment system according to claim 1,
wherein a level is set to capabilities of workers of the organization, wherein the second data includes information indicating a relationship of a level of capabilities required for the task to be performed by the organization and a level of capabilities of the worker of the organization,
wherein the worker assignment system further comprises:
a determination unit which determines a level of capabilities of the worker of the organization based on seventh data which prescribes, for each classification of work, conditions for determining that the level has reached a predetermined capability level, and
wherein the identification unit identifies a task and a worker suitable for acquiring the level of capabilities of the maximum deficient capability number based on the second data.

6. The worker assignment system according to claim 5,
wherein the identification unit identifies a classification of work to which belongs the task suitable for acquiring the level of capabilities of the maximum deficient capability number and identifies the task belonging to the identified classification of work based on the second data.

7. A worker assignment device which assigns a worker of a predetermined organization to a task to be performed by the organization, comprising:
a calculation unit which calculates a deficient capability number, which is a number of capabilities lacking in the organization at a given time in a future, from first data including information indicating a number of capabilities required for tasks previously performed by the organization and a number of capabilities of workers of the organization;
an identification unit which identifies a task and a worker suitable for acquiring capabilities of a maximum deficient capability number calculated by the calculation unit based on second data including information indicating a relationship between the capabilities required for the task to be performed by the organization and the capabilities of the workers of the organization;
an assignment unit which, after assigning the worker identified by the identification unit to the task identified by the identification unit, assigns remaining workers of the organization to remaining tasks to be performed by the organization; and
an output unit which outputs a result of the assignment by the assignment unit.
